(19) United States
(12) Patent Application Publication
(10) Pub. No.: US 2024/0412228 A1
(43) Pub. Date: Dec. 12, 2024

(54) Sensor Apparatus for Determining a Variable

(71) Applicant: HYDAC Electronic GmbH, Saarbrücken (DE)

(72) Inventors: Matthias Wolff, Saarbrücken (DE); Kai Mittermüller, Saarbrücken (DE)

(73) Assignee: HYDAC Electronic GmbH, Saarbrücken (DE)

(21) Appl. No.: 18/689,260

(22) PCT Filed: Sep. 9, 2022
(86) PCT No.: PCT/EP2022/075067

§ 371 Date: Mar. 5, 2024

(30) Foreign Application Priority Data
Sep. 14, 2021 (DE) 10 2021 004 639.0

(51) Int. Cl. G06Q 30/018; G01D 18/00; G06F 8/65

(52) U.S. Cl. CPC G06Q 30/018; G01D 18/00; G06F 8/65

(57) ABSTRACT

The invention relates to a sensor device for ascertaining a size, comprising hardware and software implemented thereon. The invention is characterized in that the software is divided into an uncertified part (10) and a part (12) which is certified on the basis of security requirements, said software parts being separated in terms of the respective software thereof and each software part having at least one computing unit (14, 16), wherein the computing units are connected together so as to communicate. The invention also relates to a working machine comprising such a sensor device and to a method for adapting such a sensor device to the respective use conditions thereof.

### CROSS-REFERENCE TO RELATED APPLICATIONS

This application claims priority to German Patent Application No. DE 10 2021 004 639.0, filed on Sep. 14, 2021 with the German Patent and Trademark Office. The contents of the aforesaid Patent Application are incorporated herein for all purposes.

### TECHNICAL FIELD

The disclosure relates to a sensor apparatus for determining a variable, comprising hardware and software implemented thereon.

### SUMMARY

A need exists to provide a sensor apparatus which can be easily and cost-effectively adapted to its respective operating conditions.

The need is addressed by the subject matter of the independent claim(s). Embodiments of the invention are described in the dependent claims, the following description, and the drawings.

### BRIEF DESCRIPTION OF THE DRAWINGS

FIG. 1 shows, not to scale, a certified and an uncertified part of a sensor apparatus according to embodiments, each having a processing unit;

FIG. 2 shows an example sequence of an algorithm for multi-sensory data fusion which is implemented on the processing unit of the uncertified part of the sensor apparatus of FIG. 1; and

FIGS. 3 and 4 each show an example sequence for an adaptation of the processing unit of the uncertified part to the respective operating conditions of the sensor apparatus.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

It has been identified that the hardware and software of a sensor apparatus used for safety-critical applications, in which the sensor apparatus has to meet increased safety requirements in the form of safety standards, such as DIN EN 61508 or DIN EN ISO 13849, must be subjected as a whole to appropriate certification by a certification organisation, for example by the TÜV, which is costly and time-consuming. If modifications are made to the hardware and software of the sensor apparatus after the aforementioned certification, for example due to adapting the software and/or hardware of the sensor apparatus to its respective operating conditions, the certification that has already taken place expires and recertification of the entire sensor apparatus must be carried out with renewed costs and time expenditure.

In some embodiments, it has been further identified that a sensor apparatus may be subdivided in terms of its software into a safety-critical and a safety-uncritical part.

In some embodiments, the sensor apparatus is characterised in that the software of the sensor apparatus is subdivided into an uncertified part and a part which is certified on the basis of safety requirements, said software parts being configured separate from each other in terms of the respective software thereof and each software part having at least one processing unit, the processing units being connected together so as to communicate.

By subdividing the software of the sensor apparatus in this way, only a safety-critical part of the software of the sensor apparatus has to be certified before it is put into operation for the first time and, if necessary, after a modification of this already certified software, whereas a further safety-uncritical part of the software of the sensor apparatus does not have to be certified. This reduces the cost and time expenditure for certification of the sensor apparatus.

Moreover, software can be provided in the part to be certified or the certified part which can be applied to any operating conditions of the sensor apparatus, whereas software can be provided in the part not to be certified or the uncertified part which can be adapted or is to be adapted to the respective operating conditions of the sensor apparatus. If the software of the sensor apparatus is subdivided accordingly, only the safety-critical part of the software of the sensor apparatus has to be certified once before it is put into operation for the first time and the sensor apparatus does not have to be recertified a second time for an adaptation to its respective operating conditions, even if the uncertified part has been modified for this purpose. This further greatly reduces the cost and time expenditure for certification of the sensor apparatus and in addition the sensor apparatus can be easily, quickly and inexpensively adapted to its respective operating conditions in a system in which the sensor apparatus is used.

In some embodiments, it is provided that at least one sensor device for detecting status values is connected to at least one of the processing units, in particular only to the processing unit of the certified part, and that the sensor apparatus is adapted in such a manner that, depending on the status values of a least one sensor device, the variable in each case can be determined by each processing unit independently of each other and that the processes of the processing units for determining the variable differ from each other. Thus, on the one hand, the variable is determined by the processing unit of the certified part in one manner and, on the other hand, by the processing unit of the uncertified part in another manner. The status values of the respective sensor device are based on the measured values recorded.

In some embodiments, it is provided that the status values of only one sensor device can be used to determine the variable by the processing unit of the certified part and the status values of at least one further sensor device can additionally be used to determine the variable by the processing unit of the uncertified part. Due to determining the variable by the processing unit of the uncertified part as a function of status values of at least one sensor device, disturbance variables acting on the respective sensor device can be at least partially subtracted out, in contrast to using status values of only one sensor device.

In some embodiments, it is provided that the software implemented on the processing unit of the uncertified part is adapted in such manner that it determines the variable by performing a fusion of the status values detected by at least two sensor devices. The corresponding software may be an algorithm for multi-sensory data fusion known in prior art, such as an (extended) Kalman filter or complementary filter.

In some embodiments, it is provided that the certified part is certified in a state in which at least one empty data field of the certified part is provided for storing configuration data of the processing unit of the uncertified part. As a result, the empty data field can be filled with data after certification of the certified part, without the already certified part being modified such that it requires recertification.

In some embodiments, it is provided that the variable is a tilt angle of the sensor apparatus relative to a reference surface. For example, it is provided in this case that at least one member of the group acceleration sensor (accelerometer), angular rate sensor (gyroscope) and magnetometer is provided in each case as a sensor device for detecting status values. For example, determination of the variable by the processing unit of the certified part is carried out using only the status values of an acceleration sensor, and determination of the variable by the processing unit of the uncertified part is carried out using the status values of the acceleration sensor, an angular rate sensor and, if necessary, a magnetometer.

In some embodiments, it is provided that at least the processing unit of the certified part, for example both processing units, has a memory device or is connected to a memory device of this part. The respective memory device can have at least one data field.

In some embodiments, it is provided that the respective processing unit is configured as a microcontroller.

In some embodiments, it is provided that at least one processing unit, in particular only the processing unit of the certified part, has an interface for connection to a fieldbus system.

Some embodiments relate to a machine, in particular a construction machine, such as a wheel loader, a mobile excavator or a truck-mounted concrete pump, having at least one movable component and at least one control system and/or a display. An above-mentioned sensor apparatus is arranged indirectly or directly on the movable component and is adapted in such a manner that it determines the tilt angle of the component with respect to a reference surface and forwards it to the control system and/or display via a connection. The reference surface can correspond to surface of the earth. A pre-definable reference system can be the earth.

Some embodiments relate to a method for adapting an above-mentioned sensor apparatus to its respective operating conditions, comprising the following method steps: Providing a part of the sensor apparatus already certified for any operating conditions; and adapting the software of the uncertified part to the respective operating conditions of the sensor apparatus, without any modification requiring recertification of the software of the already certified part of the sensor apparatus.

In some embodiments, it is provided that the software of the uncertified part is adapted by: Storing configuration data for the processing unit of the uncertified part in a respective empty data field of the already certified part; transmitting the configuration data from the processing unit of the certified part to the processing unit of the uncertified part; and adapting the software of the uncertified part to the respective operating conditions of the sensor apparatus.

In some embodiments, it is provided that the software of the uncertified part is adapted by updating it. In this way, it can be ensured in each case that for an adaptation of the processing unit of the uncertified part to the respective operating conditions of the sensor apparatus, the certified part of the sensor apparatus remains unchanged so that it does not have to be recertified.

In some embodiments, it is provided that, to indicate an update of the software of the processing unit of the uncertified part with respect to the processing unit of the certified part, a data field of the certified part already occupied by configuration data that is no longer current is cleared or an empty data field of this part is filled with a corresponding marker entry, causing the processing unit of the certified part to request current configuration data from the processing unit of the uncertified part.

In some embodiments, the following method steps are conducted: Modifying the software of the already certified part of the sensor apparatus; and recertifying the certified part of the sensor apparatus.

A sensor apparatus according to the teachings herein and the method according to the teachings herein are explained in greater detail below based on the drawings. The drawings show in principle and in schematic block diagram form.

Specific references to components, process steps, and other elements are not intended to be limiting. Further, it is understood that like parts bear the same or similar reference numerals when referring to alternate FIGS.

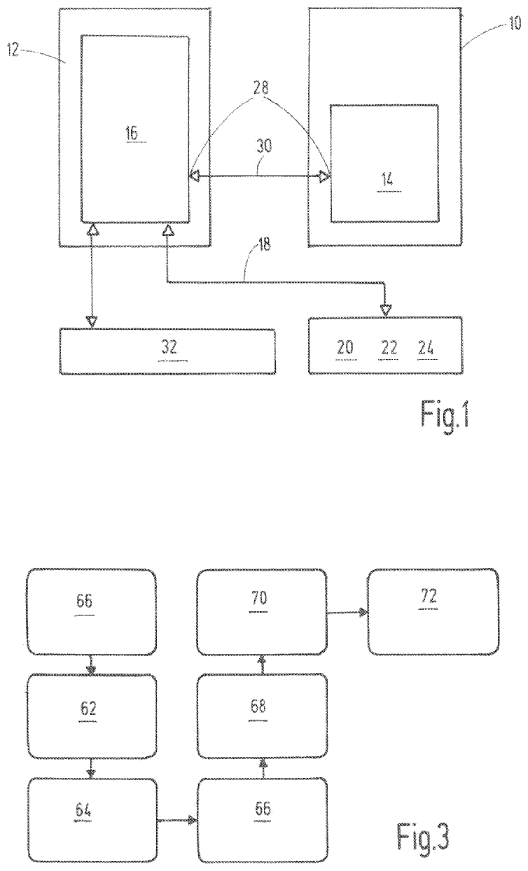

FIG. 1 shows a sensor apparatus for determining a variable. The sensor apparatus has hardware and software implemented thereon which is subdivided into an uncertified part 10 and a part 12 which is certified on the basis of safety requirements. The two parts 10, 12 are configured separate from each other with regard to their respective software. The two parts 10, 12 each have a processing unit 14, 16 which are connected to each other in a communicating manner. The hardware is at least partially shared by the uncertified part and the certified part of the software.

In the following, the processing unit 16 of the certified part 12 is also referred to as certified processing unit 16 and correspondingly the processing unit 14 of the uncertified part 10 is also referred to as uncertified processing unit 14.

Sensor devices 20, 22, 24 are each connected to the certified processing unit 16 via electrical lines 18 for detecting status values. The status values of a plurality of sensor devices 20, 22, 24 are transmitted from the respective sensor device 20, 22, 24 to the uncertified processing unit 14 via the certified processing unit 16. Using the status values of at least one of the sensor devices 20, 22, 24, the certified processing unit 16 determines the variable in one manner. Regardless of this, the uncertified processing unit 14 determines the variable by using the status values of the plurality of sensor devices 20, 22, 24 in another manner which differs at least partially from the one manner. The respective manner of determination is also referred to herein as the process of determining the variable. For example, the status values of a single sensor device 20, 22, 24 are used independently of each other by both processing units 14, 16 to determine the variable.

A software implemented on the uncertified processing unit 14 is adapted in such a manner that it calculates the variable by performing a fusion of the status values detected by a plurality of sensor devices 20, 22, 24. The corresponding software of the uncertified processing unit 14 may be an algorithm for multi-sensory data fusion known in prior art, such as an (extended) Kalman filter 26 or complementary filter, which is adapted to the present use.

Each processing unit 14, 16 has an interface 28 which interfaces are connected to each other by at least one other electrical line 30. This connection can also be realised by a bus system. The respective interface 28 for connection to the respective other processing unit 14, 16 may be present in the form of an inter-CPU interface, for example in the form of a serial peripheral interface (SPI). The certified processing unit 16 has a further interface for connection to a fieldbus system 32. The fieldbus system 32 may be configured in the form of a controller area network (CAN) fieldbus system. The protocol used in this case for data transmission can be the CanOpenSafety protocol. The certified processing unit 16 can also have or be connected to a memory device not shown in the FIGS. A respective sensor device 20, 22, 24 can be configurable by the certified processing unit 16.

The processing units 14, 16 are each configured as microcontrollers.

In this case, the variable is a tilt angle of the sensor apparatus relative to a reference surface. The sensor devices 20, 22, 24 used to determine the tilt angle are an acceleration sensor 20, an angular rate sensor 22 and, if necessary, a magnetometer 24. The tilt angle is determined in each processing unit 14, 16 independently of each other. In each case, the certified processing unit 16 determines, using only the status values of the acceleration sensor 20, and the uncertified processing unit 14 determines, using the respective status values of the acceleration sensor 20, the angular rate sensor 22 and, if necessary, the magnetometer 24, the tilt angle independently of each other. The tilt angle determined by the uncertified processing unit 14 is finally transmitted to the certified processing unit 16, for example via the electrical line 30, via which the status values of the sensor devices 20, 22, 24 can also pass from the certified processing unit 16 to the uncertified processing unit.

The two variables in the form of the tilt angles determined by the processing units 14, 16 represent output signals of the sensor apparatus which are for example emitted to the fieldbus system 32, in particular by the certified processing unit 16.

If the acceleration sensor 20 arranged in any position is at rest, only the acceleration due to gravity (gravitation) g acts on it, which can be detected by the acceleration sensor 20 in the form of a vector (perpendicular). By comparing the currently detected vector with a vector which the acceleration sensor 20 detects in a reference position, it is possible to determine the tilt of the sensor apparatus, in particular of the acceleration sensor, in relation to the surface of the earth. The reference position can correspond to an initial rest position of the sensor apparatus. Thus, when the sensor apparatus is at rest in any position, the tilt angle of the sensor apparatus can depend only or at least on the tilt angle of the certified processing unit 16.

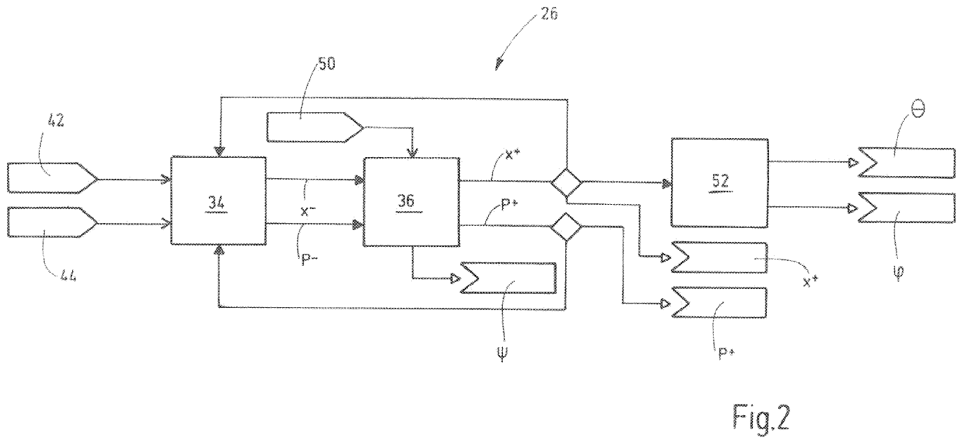

If the acceleration sensor 20 is not at rest but is performing a movement, in particular an accelerated movement, further accelerations act on the acceleration sensor 20 in addition to the acceleration due to gravity g, for example due to a centrifugal force and/or an externally specified vibration. In the case of the moving acceleration sensor 20, these further accelerations represent disturbance variables for determining the tilt of the acceleration sensor 20, which result in an incorrectly detected vector (apparent perpendicular). The algorithm for multi-sensory data fusion is used to reduce, at best compensate for, these disturbance variables, for which it uses the status values of the angular rate sensor 22 and, if necessary, the magnetometer 24 in order to correct the status values of the acceleration sensor 20. By way of example for the algorithm for multi-sensory data fusion, FIG. 2 shows an extended Kalman filter 26, known in prior art and adapted to the present use, which as usual comprises a prediction step 34 and a correction step 36. In the prediction step 34, using a physical system model of the system in which the sensor apparatus is used, a prediction expectation value x⁻ and a prediction covariance P⁻ are calculated as a function of the estimated current expectation value x⁺ and the estimated current covariance P⁺ and, if applicable, the status values 42, 44 of the acceleration sensor 20 and the angular rate sensor 22, which are corrected in the subsequent correction step 36 by means of current status values 50. The current status values may be a velocity. The estimated current expectation value x⁺ and the estimated current covariance P⁺, which are fed back into the prediction step 34 and from which the tilt angle can be derived, are obtained following the correction step 36. For this purpose, depending on the estimated current expectation value x⁺, a calculation 52 of the Euler angles θ, φ can be performed and/or a correction value ψ can be obtained, in particular from the correction step 36. Adaptation of the physical system model to the respective system, for example a machine in which the sensor apparatus can be deployed, can be the cause for an adaptation of the uncertified part 10 to its respective operating conditions in this system.

At least the sensor devices 20, 22, 24 of the sensor apparatus can be combined as a marketable unit and arranged in a common housing not shown in the FIGS. In this case, the sensor devices 20, 22, 24 can be arranged in the housing as to be stationary with respect to the housing. If, in the present case, a state of rest or a state of motion of the sensor apparatus is referred to, this state focuses at least on the sensor devices 20, 22, 24 of the sensor apparatus.

The sensor apparatus is part of a system in the form of a mobile machine, for example a wheel loader, a mobile excavator or a truck-mounted concrete pump. FIG. 1 shows only the fieldbus system 32 of the system. The machine comprises the fieldbus system 32 and a movable component in the form of a boom to which the sensor apparatus is indirectly or directly connected. The sensor apparatus is adapted in such a manner that it determines the tilt angle of the component with respect to the reference surface and forwards it to the fieldbus system 32.

The certified part 12 can be used in various systems, i.e., under various operating conditions, without having to adapt it to the respective system as part of a modification to its software, which would result in recertification thereof. The uncertified part 10 can be adapted or has to be adapted to a respective system as part of modifying its software, without causing a modification, requiring certification, of the software of the certified part 12 of the sensor apparatus.

The certified part 12 is certified in a state in which at least one empty data field of the certified part 12 is provided for storing configuration data of the uncertified processing unit 14. The empty data field is located in a memory device of the certified part 12 not shown in the FIGS.

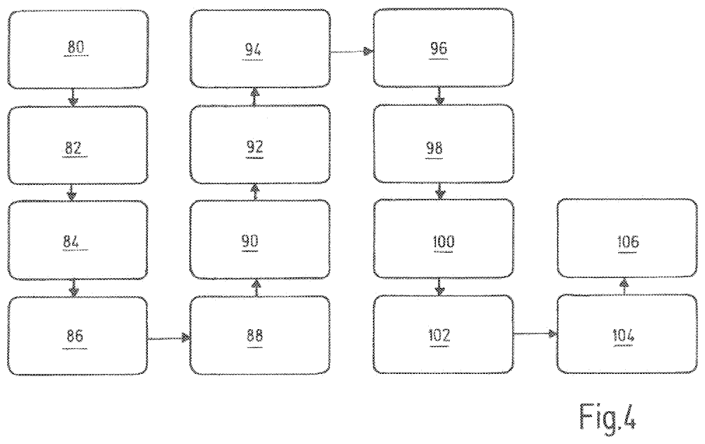

The uncertified part 10 can be adapted to a respective system in which the sensor apparatus is used by storing configuration data for the uncertified processing unit 14 in a respective empty data field of the already certified part 12. After a reboot 60 of the sensor apparatus (FIG. 3) as part of starting up (booting) said sensor apparatus, an initialisation 62 of the certified processing unit 16 is initially performed, after which it is ready for use 64. Subsequently, an initialisation 66 of the uncertified processing unit 14 is performed, whereupon said unit makes a request 68 for its configuration data to the certified processing unit 16. In a next step, a transmission 70 of this data from the certified processing unit 16 to the uncertified processing unit 14 is performed. Finally, the software of the uncertified processing unit 14 is adapted to the respective system, i.e., the respective operating conditions prevailing there, by means of the configuration data transmitted. Thereafter, the uncertified processing unit 14 is ready for use 72.

Alternatively or additionally, the uncertified part 10 can be adapted to the respective system by updating the software of the uncertified processing unit 14. After a reboot 80 of the sensor apparatus (FIG. 4), an initialisation 82 of the certified processing unit 16 is performed. Subsequently, the certified processing unit 16 is brought into a tunnel mode 84, whereupon an initialisation 86 of the uncertified processing unit 14 is performed. Thereafter, the uncertified processing unit 14 is put in an update state 88 in which an update 90 of its software is subsequently performed. Following this, a reset 92 or deletion of a data field of the certified part 12, which was previously occupied by configuration data, is performed for the purpose of identifying the update of the software of the uncertified processing unit 14 compared to the certified processing unit 16. Thereupon, a reboot 94 of the sensor apparatus is performed, following which the uncertified processing unit 14 makes a request 96 for its configuration data to the certified processing unit 16. Hereafter, an identification 98 of the cleared data field of the certified part 12 as cleared takes place, which causes the certified processing unit 16 to make a request 100 for configuration data to the uncertified processing unit 14. Thereupon, a transmission 102 of the configuration data from the uncertified processing unit 14 to the certified processing unit 16 is performed. In the next step, a storage 104 of the configuration data in an empty data field of the certified part 12 is performed, whereupon a reboot 106 of the sensor apparatus is finally performed.

In the present case, a reboot 60, 80, 94, 106 of the sensor apparatus corresponds at least to a reboot of the software of each processing unit 14, 16. The said data field of the certified part 12 can be edited via the object dictionary and can be provided in a memory device in the form of a ferroelectric random-access memory (FRAM).

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-12. (canceled)

13. A sensor assembly for determining a variable, comprising hardware and software implemented thereon, wherein the software is subdivided into an uncertified part and a part which is certified on the basis of safety requirements, said software parts being configured separate from each other in terms of the respective software thereof and each part having at least one processor, the processors being connected together so as to communicate.

14. The sensor assembly of claim 13, wherein at least one sensor for detecting status values is connected to a least one of the processors, wherein the sensor assembly is adapted in such a manner that, depending on the status values of the at least one sensor, the variable can be determined by each processor independently of each other, and wherein processes of the processors for determining the variable differ from each other.

15. The sensor assembly of claim 14, wherein the status values of only one sensor are used to determine the variable by the processor of the certified part and at least the status values of this sensor are additionally used to determine the variable by the processor of the uncertified part.

16. The sensor assembly of claim 13, wherein the software implemented on the processor of the uncertified part is adapted in such manner that it determines the variable by performing a fusion of the status values detected by at least two sensor devices.

17. The sensor assembly of claim 13, wherein the certified part is certified in a state in which at least one empty data field of the certified part is provided for storing configuration data of the processor of the uncertified part.

18. The sensor assembly of claim 13, wherein at least one member of the group of acceleration sensor, angular rate sensor, and magnetometer is provided as the sensor for detecting status values.

19. The sensor assembly of claim 13, wherein the variable is a tilt angle of the sensor assembly relative to a reference surface.

20. The sensor assembly of claim 13, wherein, when the sensor assembly is at least partially at rest in a predefinable reference system, a tilt angle of the sensor assembly can be determined at least by the processor of the certified part and/or, when the sensor assembly is moved at least partially relative to this reference system, the tilt angle of the sensor assembly can be determined at least by the processor of the uncertified part.

21. A machine with at least one movable component and at least one control system and/or one display, wherein a sensor assembly according to claim 13 is associated with the movable component, which sensor assembly is adapted in such a manner that it determines the tilt angle of the component with respect to a reference surface and forwards it to the control system and/or the display via a connection.

22. A method for adapting a sensor assembly to its respective operating conditions, comprising:
providing a part of the sensor assembly which is already certified for any operating conditions; and
adapting software of an uncertified part to the respective operating conditions of the sensor assembly, without any modification requiring certification of software of the certified part of the sensor assembly.

23. A method of claim 22, wherein the software of the uncertified part is adapted by:
storing configuration data for a processor of the uncertified part in a respective empty data field of the already certified part;
transmitting the configuration data from the certified part to the uncertified part; and
adapting the software of the uncertified part to the respective operating conditions.

24. A method of claim 22, wherein the software of the uncertified part is adapted by updating it.

25. The sensor assembly of claim 14, wherein the software implemented on the processor of the uncertified part is adapted in such manner that it determines the variable by performing a fusion of the status values detected by at least two sensor devices.

26. The sensor assembly of claim 15, wherein the software implemented on the processor of the uncertified part is adapted in such manner that it determines the variable by performing a fusion of the status values detected by at least two sensor devices.

27. The sensor assembly of claim 14, wherein the certified part is certified in a state in which at least one empty data field of the certified part is provided for storing configuration data of the processor of the uncertified part.

28. The sensor assembly of claim 15, wherein the certified part is certified in a state in which at least one empty data field of the certified part is provided for storing configuration data of the processor of the uncertified part.

29. The sensor assembly of claim 16, wherein the certified part is certified in a state in which at least one empty data field of the certified part is provided for storing configuration data of the processor of the uncertified part.

30. The sensor assembly of claim 14, wherein at least one member of the group of acceleration sensor, angular rate sensor, and magnetometer is provided as the sensor for detecting status values.

31. The sensor assembly of claim 15, wherein at least one member of the group of acceleration sensor, angular rate sensor, and magnetometer is provided as the sensor for detecting status values.

32. The sensor assembly of claim 16, wherein at least one member of the group of acceleration sensor, angular rate sensor, and magnetometer is provided as the sensor for detecting status values.
